(19) United States
(12) Patent Application Publication
(10) Pub. No.: US 2020/0276541 A1
(43) Pub. Date: Sep. 3, 2020

(54) Sanitary Membrane Cartridge for Reverse Osmosis Filtration

(71) Applicant: Sandymount Technologies Corporation, Woburn, MA (US)

(72) Inventors: Ronan K. McGovern, Cambridge, MA (US); Ted Prato, Cambridge, MA (US); Adam Weiner, Cambridge, MA (US); Grace Connors, Cambridge, MA (US); Robert Lederman, Walpole, MA (US)

(21) Appl. No.: 16/761,738

(22) PCT Filed: Nov. 6, 2018
(86) PCT No.: PCT/US18/59457

§ 371 Date: May 5, 2020

Related U.S. Application Data
(60) Provisional application No. 62/582,116, filed on Nov. 6, 2017.

(51) Int. Cl. B01D 69/04; B01D 63/10; B01D 61/08

(52) U.S. Cl. CPC B01D 69/043; B01D 63/10; B01D 2313/083; B01D 2313/04; B01D 61/08

(57) ABSTRACT

A sanitary membrane cartridge for use in reverse osmosis filtering includes an outer housing, a central core tube, and a membrane leaf wound around the central core tube to form a cylindrical filter. The cartridge further includes a sealant layer disposed around the cylindrical filter to form a sealed filter, the sealed filter disposed within the housing. The sealant layer preferably has a surface roughness value, Ra, ranging from about 0.38 μm to about 0.82 μm. The cartridge further includes a brine seal, disposed between the sealant layer and the housing, having one or more notches formed on an outer diameter of the brine seal such that the feed flow through the notches allows bypass flow, between the sealant layer and the housing, of 1% to 25% of a total feed flow through the sealed filter.

### CROSS-REFERENCE TO RELATED APPLICATIONS

This application claims priority to U.S. Provisional Patent Application No. 62/582,116, filed Nov. 6, 2017, the disclosure of which is incorporated by reference herein in its entirety.

### TECHNICAL FIELD

The present invention relates to reverse osmosis membrane elements, and more particularly to high pressure sanitary reverse osmosis membrane elements.

### BACKGROUND ART

Non-sanitary reverse osmosis membrane elements are typically designed for use with a brine seal that directs cross-flow of the subject liquid through the element and prevents flow from bypassing the element. The brine seal creates a stagnation zone between the outer wrap of the element and the inner surface of the pressure vessel in which the one or more reverse osmosis elements are located. Because bacteria and other microbes can potentially accumulate and grow in a stagnation zone, the presence of a stagnation zone is inconsistent with sanitary operation.

The prior art discloses reverse osmosis membrane elements, for sanitary operation, that are designed to avoid the presence of stagnant zones. One approach to making an element sanitary is to eliminate the brine seal and to instead allow some bypass flow around the element. For example, one can wrap a permeable mesh around the element. However, especially under high flow conditions, the mesh tends to move and deform during operation, making it difficult to keep the bypass flow to a reasonably low level. In another example, Pearl (U.S. Pat. No. 5,128,037) and Knappe (U.S. Pat. No. 5,985,146) seek to reduce the problems associated with a soft outer mesh by placing the membrane cartridge within a hard tube, which keeps the gap between the hard tube and the housing more consistent. However, two problems with this method are that (1) often the hard shell can slip off the membrane cartridge, which seems to be a problem when operating with high pressures and flows, and (2) the hard shells require time and expense to design and build relative to that of a typical fiberglass shell. Zimmerly (U.S. Pat. No. 4,064,052A), in a separate but related application, used soft brine seals with holes to avoid stagnant zones.

### SUMMARY OF THE EMBODIMENTS

In accordance with one embodiment of the invention, a sanitary membrane cartridge is provided for use in reverse osmosis filtering. The cartridge includes a housing, a central core tube, a membrane leaf wound around the central core tube to form a cylindrical filter. The cartridge further includes a sealant layer disposed around the cylindrical filter to form a sealed filter, the sealed filter disposed within the housing. The sealant layer preferably has a surface roughness value, Rₐ, ranging from about 0.38 μm to about 0.82 μm (about 15 to 32 microinches). The cartridge further includes a brine seal, which is disposed between the sealant layer and the housing, having one or more notches formed on an outer diameter of the brine seal such that feed flow through the notches allows bypass flow, between the sealant layer and the housing, of 1% to 25% of a total feed flow through the sealed filter.

In related embodiments, the one or more notches may have a semi-circular shape. A diameter of the semi-circular shape may be no larger than about 10 mm, e.g., the diameter may range from about 2 mm to about 10 mm, and preferably may range from about 3 mm to about 6 mm. The brine seal may include 2 to 8 notches, preferably 3 to 4 notches.

In related embodiments, the central core tube may include stainless steel and/or plastic. Optionally, the plastic may be acrylonitrile butadiene styrene (ABS), NORYL® (also known as PPO or polyphenylene), polysulfone, and/or Fiberglass Reinforced Plastic (FRP).

In another related embodiment, a diameter of the sanitary membrane cartridge may be about 4 inches. Optionally, an inner diameter of the central core tube may range from about 0.4 to about 0.55 inches, and preferably ranges from about 0.475 to about 0.525 inches. An outer diameter of the central core tube may range from about 0.75 to about 0.9 inches. The outer diameter may be turned down or tapered to about 0.75 inches at each end of the central core tube.

In yet another related embodiment, a diameter of the sanitary membrane cartridge may be about 8 inches. An inner diameter of the central core tube may range from about 0.8 to about 1.15 inch. An inner diameter of the central core tube may range from about 0.8 to about 1.1 inches. An outer diameter of the central core tube may range from about 1.55 to about 1.8 inches. An outer diameter of the central core tube may range from about 1.65 to about 1.8 inches.

In another related embodiment, the cartridge may further include an anti-telescoping device positioned on at least one end of the cylindrical filter. The anti-telescoping device may include an end plate having round holes that allows fluid flow through the round holes.

In yet another related embodiment, the permeate carrier may be a tricot or a simplex-type permeate carrier.

In accordance with another embodiment of the invention, a sanitary membrane cartridge is provided for use in reverse osmosis filtering. The cartridge includes a housing, a central core tube, a membrane leaf wound around the central core tube to form a cylindrical filter. The cartridge further includes a sealant layer disposed around the cylindrical filter to form a sealed filter, the sealed filter disposed within the housing. The sealant layer preferably has a surface roughness value, Rₐ, ranging from about 0.38 μm to about 0.82 μm (about 15 to 32 microinches), and has an array of holes such that feed flow through the array of holes allows bypass flow, between the sealant layer and the housing, of 1% to 25% of a total feed flow through the sealed filter.

In related embodiments, the array may include 1 to 8 holes and one or more of the holes may be about 2 mm to about 10 mm in diameter, preferably about 3 mm to about 6 mm in diameter. The central core tube may include stainless steel and/or plastic. The plastic may include acrylonitrile butadiene styrene (ABS), PPO, polysulfone, and/or Fiber Reinforced Plastic (FRP). A diameter of the sanitary membrane cartridge may be about 4 inches. An inner diameter of the central core tube may range from about 0.4 to about 0.55 inches, preferably about 0.475 to about 0.525 inches. An outer diameter of the central core tube may range from about 0.75 to about 0.9 inches. The outer diameter may be turned down or tapered to about 0.75 inches at each end of the central core tube. Alternatively, a diameter of the sanitary membrane cartridge may be about 8 inches. In this case, an inner diameter of the central core tube may range from about 0.8 to about 1.1 inches. An outer diameter of the central core tube may range from about 1.55 to about 1.8 inches. The cartridge may further include an anti-telescoping device positioned on at least one end of the cylindrical filter. The anti-telescoping device may include an end plate having round holes and be configured to allow fluid flow through the round holes. The permeate carrier may be a tricot or a simplex-type permeate carrier.

### BRIEF DESCRIPTION OF THE DRAWINGS

The foregoing features of embodiments will be more readily understood by reference to the following detailed description, taken with reference to the accompanying drawings, in which:

FIG. 1 is a diagram of a conventional prior art seawater filtration element;

FIG. 2 is a diagram of an exemplary reverse osmosis membrane cartridge, in accordance with an embodiment of the present invention;

FIG. 3 is a diagram of an alternative exemplary reverse osmosis membrane cartridge, in accordance with an embodiment of the present invention;

FIG. 3A shows a brine seal with a notched design in accordance with an embodiment of the present invention; FIG. 4 is a diagram of an exemplary anti-telescoping device used in the cartridge of FIG. 2, in accordance with an embodiment of the present invention; and

FIG. 5 is a diagram of an exemplary anti-telescoping device used in the cartridge of FIG. 3, in accordance with an embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

A “set” includes at least one member.

The embodiments described herein allow for the processing of solutions at high pressures, such as above 1200 psi, and with minimal dead zones in which bacteria can accumulate and/or grow. The disclosure is directed towards addressing these drawbacks and ensuring the element is safe for operation at pressures above 1,200 psi.

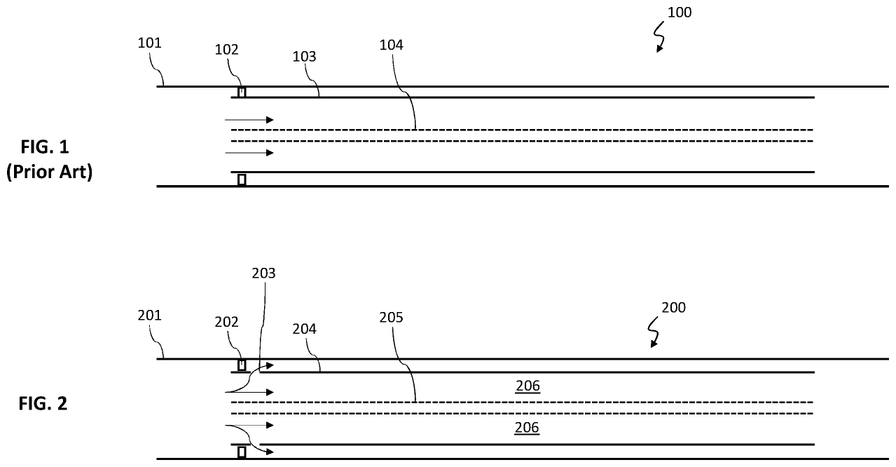

FIG. 1 is a diagram of a conventional prior art seawater filtration element or cartridge. The seawater filtration element 100 includes a housing 101, which is typically made of fiberglass. The element 100 includes a permeate core tube 104 having perforations along its length to allow from flow from the outside of the core tube 104 to the inside of the core tube 104. The filtration element 100 includes an impermeable sealant layer 103 (often made of fiberglass and epoxy) on a spiral wound membrane cartridge. The filtration element 100 includes a brine seal 102, which is typically a “U-cup” type seal that prevents liquid flow between the sealant layer 103 and the housing 103, rather than through the element. In this exemplary conventional element, membrane envelopes, comprised of permeate carrier, membrane flatsheet and feed spacer are arranged spirally around the core tube 104 and inside the housing 101.

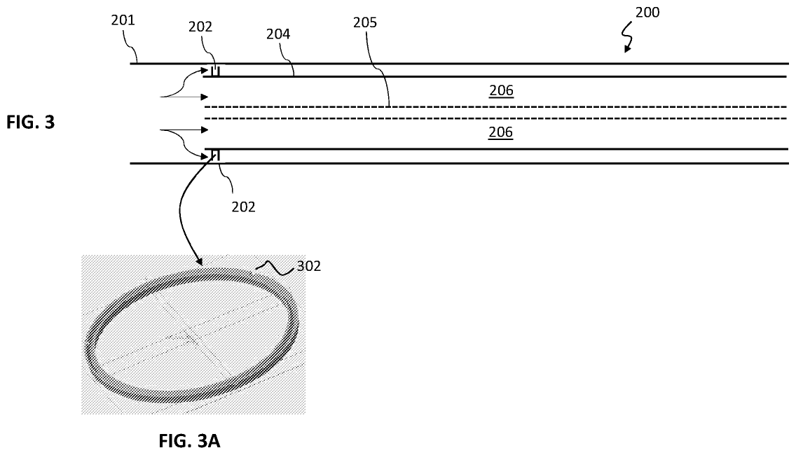

FIG. 2 is a diagram of an exemplary reverse osmosis membrane element or cartridge 200, in accordance with an embodiment of the invention. The cartridge 200 includes one or more membrane leaves wrapped around a membrane core tube 205 to form a cylindrical filter 206. The membrane core tube 205 has perforations along its length to allow fluid flow from the outside of the core tube 205 to the inside of the core tube 205 through the membrane leaves. The cartridge 200 also includes an impermeable sealant layer 204, preferably having a surface roughness value, Rₐ, ranging from about 0.38 μm to about 0.82 μm (about 15 to 32 microinches) surrounding the cylindrical filter 206 to form a sealed filter. The sealed filter is disposed within a housing 201. The cylindrical filter 206 includes spirally configured membrane leaves, a permeate carrier, and a feed spacer, as known by one skilled in the art. The cartridge 200 also includes a brine seal 202 between the housing 201 and the sealant layer 204. In the embodiment shown in FIG. 2, the cartridge 200 includes, at least one hole 203 in the sealant layer 204 configured to allow bypass flow between the sealant layer 204 and the housing 201. The at least one hole 203 can include two or more holes. In some embodiments, the two or more holes can be distributed around the circumference of the sealant layer 204. The at least one hole allows a small portion of the fluid flow to bypass the membrane leaves, making the reverse osmosis element more sanitary and robust for operation at higher pressures. Alternatively, as shown in FIG. 3, one or more notches 302 may be formed in the brine seal 202, e.g., two to eight equally spaced notches, distributed around the outer circumference of the brine seal 202, to allow a small portion of the flow to bypass the membrane leaves, making the reverse osmosis element more sanitary and robust for operation at higher pressures. The one or more notches may have a semi-circular shape with a diameter no larger than about 10 mm. For example, the diameter may range from about 2 mm to about 10 mm, and preferably may range from about 3 mm to about 6 mm. In reverse osmosis, where vessel drainage is difficult, a notched brine seal is preferred over holes in a brine seal. The notches, when placed at the brine seal edge that contacts the housing 201 wall, does not impede drainage as would a bypass hole situated away from the vessel wall.

Various embodiments of the cartridge 200 may include some or all of the following modifications:

Final epoxy coating. The typical fiberglass-epoxy wrap of spiral round elements can be somewhat rough. The roughness creates a risk of sites for the growth and/or accumulation of bacteria in the element, resulting in unsanitary conditions. One solution to this challenge is to add an additional layer, namely, impermeable sealant layer 204, of a smooth epoxy to the wrap, e.g., having a surface roughness value Rₐ of preferably about 0.38-0.82 μm (about 15-32 microinches). In some embodiments, this finishing layer, the impermeable sealant layer 204, is made of other suitable materials that are food grade.

Bypass holes. A controlled way to allow for bypass flow around the membrane, rather than through the membrane, and also to avoid the back flow around the opposite end of the membrane, is to drill a set of holes 203 just behind the brine seal 202 in the sealant layer 204. In a preferred embodiment, the holes 203 should not be drilled so far from the brine seal that they are inside the glue line of the membrane envelopes—that would seriously damage membrane performance. For example, for a four-inch diameter cartridge 200, between two and eight holes 203 of between 1/10 and ¼ of an inch are appropriate to provide some reasonable level of bypass flow.

Brine seal with notches. Another controlled way to allow for bypass flow around the membrane, rather than through the membrane, is to include one or more notches 302 in the brine seal 202. As mentioned above, vessel drainage is difficult in reverse osmosis systems and a notched brine seal provides the additional benefit of allowing fluid that may remain in the bypass area after the reverse osmosis process is complete to drain out of the area between the housing 201 and the sealant layer 204. For example, if a plurality of notches are used around the outer edge of the seal, then one or more notches will be oriented towards the bottom of the cartridge 200 and allow the fluid to drain when the filtration process is complete. This is an improved design over holes within a brine seal, which are located some distance away from the housing wall and would therefore impede the drainage of any fluid. Preferably, the notches 302 are sized such that the brine seals 202 still hold the membrane in place during operation.

Core tube selection. Core tubes for seawater elements are typically designed for operation at 1,200 psi, plus a factor of safety. For operation at higher pressures, the same core tubes often do not provide enough strength against collapse. One particular point of weakness is the ends of the core tubes 205. These tubes are often machined (on the outer diameter for four-inch diameter elements and on the inner diameter for eight-inch diameter elements) resulting in a reduction of the wall thickness and, consequently, of the wall strength. One solution for high-pressure core tubes is to make them of stainless steel. However, stainless steel tubes are difficult to machine, heavy and costly to manufacture. Seawater core tubes for four-inch diameter elements typically employ an inner diameter of 0.55″ and 0.6″ and a turned down or tapered outer diameter of 0.75″ at the core tube ends. In an exemplary embodiment, it is advantageous to employ plastic core tubes (whether ABS, or preferably, NORYL® [also known as PPO or polyphenylene], or polysulfone) with an inner diameter of between about 0.4″ and 0.55″, or, more preferably, between about 0.475″ and 0.525″. The outer diameter should be no less than about 0.75″ and no greater than about 0.9″ and turned down or tapered to 0.75″ at the ends. Eight-inch diameter seawater elements (typically with female ends) typically have a turned inner diameter of about 1.125″ or larger, and an outer diameter of about 1.5″. In an exemplary embodiment, it is advantageous to employ an outer diameter of between about 1.55″ and 1.8″, or more preferably between about 1.65″ and 1.8″. In another embodiment, a different end connector can be used to allow for a smaller turned inner diameter of between about 0.8″ and 1.1″.

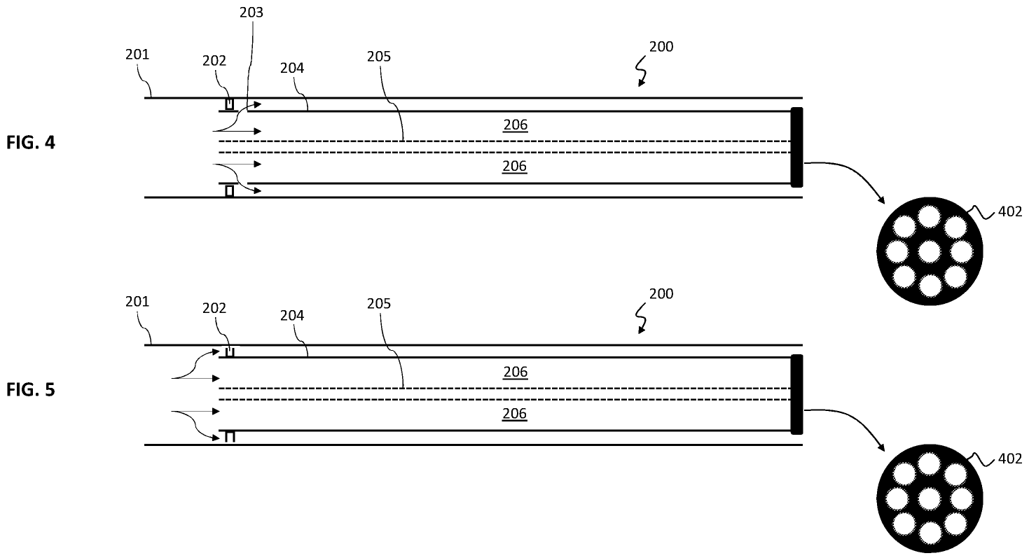

Anti-telescoping device. An anti-telescoping device (ATD) and, in some cases, thrust rings are employed in seawater membranes. These ATDs may have sharp radii prone to growth of bacteria. In an exemplary embodiment, for sanitary reasons, it is more advantageous to employ ATDs having rounded geometries. One example of a typical ATD is a hub and spoke type design having these sharp radii. FIGS. 4 and 5 are diagrams of an exemplary ATD 402 used in cartridge 200 in the form of an end plate having round holes to allow through-flow. The ATD(s) can be positioned on one or both ends of the elements or cartridge. In some embodiments, the bypass holes can be formed in the ATD(s) or the brine seal.

Permeate carrier. Typically, seawater membranes employ a tricot for the permeate carrier, often made of polypropylene. Such a permeate carrier may also be employed for a high-pressure element. In an exemplary embodiment, instead of a tricot, a simplex-type permeate carrier can be used in the cylindrical filter 206, the simplex-type permeate carrier providing symmetrical support (rather than the asymmetric support of a tricot).

Rolling. The membranes may be rolled by hand or, preferably, using an autowinder, resulting in a better quality membrane element with the greater solute rejection properties.

The embodiments of the invention described above are intended to be merely exemplary; numerous variations and modifications will be apparent to those skilled in the art. All such variations and modifications are intended to be within the scope of the present invention as defined in any appended claims.

1. A sanitary membrane cartridge for use in reverse osmosis filtering, the cartridge comprising:
a housing;
a central core tube;
a membrane leaf wound around the central core tube to form a cylindrical filter;
a sealant layer disposed around the cylindrical filter to form a sealed filter, the sealed filter disposed within the housing; and
a brine seal disposed between the sealant layer and the housing, the brine seal having one or more notches formed around an outer diameter of the brine seal such that feed flow through the notches allows bypass flow, between the sealant layer and the housing.

2. (canceled)

3. (canceled)

4. (canceled)

5. (canceled)

6. (canceled)

7. A cartridge according to claim 1, wherein the central core tube comprises stainless steel.

8. A cartridge according to claim 1, wherein the central core tube comprises plastic.

9. A cartridge according to claim 8, wherein the plastic is selected from the group consisting of acrylonitrile butadiene styrene (ABS), PPO, polysulfone, Fiber Reinforced Plastic (FRP), or combinations thereof.

10. A cartridge according to claim 1, wherein a diameter of the sanitary membrane cartridge is about 4 inches.

11. A cartridge according to claim 10, wherein an inner diameter of the central core tube ranges from about 0.4 to about 0.55 inches.

12. A cartridge according to claim 11, wherein the inner diameter of the central core tube ranges from about 0.475 to about 0.525 inches.

13. (canceled)

14. (canceled)

15. A cartridge according to claim 1, wherein a diameter of the sanitary membrane cartridge is about 8 inches.

16. A cartridge according to claim 15, wherein an inner diameter of the central core tube ranges from about 0.8 to about 1.1 inches.

17. A cartridge according to claim 16, wherein an outer diameter of the central core tube ranges from about 1.55 to about 1.8 inches.

18. A cartridge according to claim 10, wherein an outer diameter of the central core tube ranges from about 0.75 inches to about 0.9 inches.

19-40. (canceled)

41. A cartridge according to claim 1, wherein the sealant layer has a surface roughness value, Rₐ, ranging from about 0.38 μm to about 1.8 μm.

42. A cartridge according to claim 1, wherein the feed flow through the notches allows bypass flow, between the sealant layer and the housing, of 1% to 25% of a total feed flow through the sealed filter.

43. A sanitary membrane cartridge for use in reverse osmosis filtering, the cartridge comprising:
a housing;
a central core tube;
a membrane leaf wound around the central core tube to form a cylindrical filter;
a sealant layer disposed around the cylindrical filter to form a sealed filter, the sealed filter disposed within the housing;
a brine seal disposed between the sealant layer and the housing; and
wherein a diameter of the sanitary membrane cartridge is about 4 inches, the central core tube comprises plastic, an inner diameter of the central core tube ranges from about 0.4 to about 0.55 inches, and an outer diameter of the central core tube ranges from about 0.75 to about 0.9 inches.

44. A cartridge according to claim 43, wherein the inner diameter of the central core tube ranges from about 0.475 to about 0.525 inches.

45. A cartridge according to claim 43, wherein the plastic is selected from the group consisting of acrylonitrile butadiene styrene (ABS), PPO, polysulfone, Fiber Reinforced Plastic (FRP), or combinations thereof.

46. A sanitary membrane cartridge for use in reverse osmosis filtering, the cartridge comprising:
a housing;
a central core tube;
a membrane leaf wound around the central core tube to form a cylindrical filter;
a sealant layer disposed around the cylindrical filter to form a sealed filter, the sealed filter disposed within the housing;
a brine seal disposed between the sealant layer and the housing; and
wherein a diameter of the sanitary membrane cartridge is about 8 inches, the central core tube comprises plastic, an inner diameter of the central core tube ranges from about 0.8 to about 1.1 inches, and an outer diameter of the central core tube ranges from about 1.55 to about 1.8 inches.

47. A cartridge according to claim 46, wherein the plastic is selected from the group consisting of acrylonitrile butadiene styrene (ABS), PPO, polysulfone, Fiber Reinforced Plastic (FRP), or combinations thereof.
